(19) United States
(12) Patent Application Publication
(10) Pub. No.: US 2003/0087633 A1
(43) Pub. Date: May 8, 2003

(54) Method of processing mobile application part protocol in the mobile communication system

(75) Inventor: Seung Eon Yoon, Anyang-shi (KR)

Correspondence Address: FLESHNER & KIM, LLP, 14500 AVION PARKWAY, SUITE 125, CHANTILLY, VA, 20151, US

(73) Assignee: LG Electronics Inc.

(21) Appl. No.: 10/281,978

(22) Filed: Oct. 29, 2002

(30) Foreign Application Priority Data
Nov. 5, 2001 (KR) 2001/68472

(51) Int. Cl. H04Q 7/20

(52) U.S. Cl. 455/418; 455/423

(57) ABSTRACT

A method of processing MAP protocol in a mobile communication system is disclosed. The method reduces the processing time of certain Application Process (AP) having a long life cycle by storing information related to such AP in a database and not in the context pool at the time of exchanging MAP protocol messages between the mobile communication systems. Additionally, the performance information and state are continuously updated and stored in the relevant database until the relevant transaction is completed.

### BACKGROUND OF THE INVENTION

1. Field of the Invention

The present invention relates to a method of processing Mobile Application Part (MAP) protocol in a mobile communication system, and in particular to a method of processing MAP protocol in the mobile communication system by storing information related to certain Application Processes (AP) in a database at the time of exchanging MAP protocol messages between mobile communication systems.

2. Background of the Related Art

The International Mobile Telecommunication (IMT)-2000 core network includes a number of network entities and provides a subscriber with mobility through a combination of the relevant network entities. Also, through the information exchange between the relevant network entities, the network can provide a variety of services, including the location registry for mobile subscribers, call process, and various additional services.

For example, a relevant network entity may include a Home Location Register (HLR), a Mobile Switching Center (MSC), a Visitor Location Register (VLR), a Base Station (BS), an Authentication Center (AC), and a Short Message Center (SMC).

Referring to FIG. 1, a related art network element of the IMT-2000 core network for processing MAP messages is shown. The network element includes a Mobile Application Part (MAP) 100, a Transaction Capability Application Part (FCAP) 200, a Signaling Connection Control Part (SCCP) 300, and a Message Transfer Part (MTP) 400.

The MAP 100 includes a context pool 110, a MAP protocol process AP 120, and a number of other APs. The TCAP 200 includes a Dialogue Handling block (DHA) 210, a Component Handling block (CHA) 220, and a Transaction Sub-layer (TSL) 230. The MTP 400 includes an MTP1 410, an MTP2 420, and an MTP3 430.

Further, the mobile communication system for providing MAP protocol, which is a communication protocol of the IMT-2000 core network, comprises a number of Application Processes (APs). The AP has common functions, which include processing the TCAP protocol, MAP protocol encoding and decoding, managing the context pool, administrating IDs (such as a transaction Identities (IDs) and protocol message invoke IDs), and the database function.

More specifically, for processing the TCAP protocol, a TCAP of a No. 7 common channel signaling network provides various functions. These include a function of a processing component, a function of a processing dialogue, and a function of processing a transaction for information exchange between Application Service Elements (ASEs) on a signaling point. The relevant ASEs achieve a remote operation using the above functions. Here, the above-described functions of processing the TCAP protocol ate the functions for processing de-capsulated MAP data, TCAP dialogues, and transaction messages.

The input and output of the function of processing the TCAP protocol are made through TCAP protocol messages. The details of the TCAP protocol message are as follows.

The begin message (TC_BEGIN_REQ/IND) is a message indicating that a new dialogue has begun. The end message (TC_END_REQ/IND) is a message indicating that the dialogue has ended. The continue message (TC_CONTINUE_REQ/IND) is a message indicating that the dialogue is continuing. The abort message by a user (TC_U_ABORT_REQ/IND) is a message used when the ASE abruptly ends the currently continuing dialogue. The abort message by a transaction sub-layer (TC_P_ABORT_REQ/IND) is a message used to end the dialogue at the TCAP when the dialogue information is wrong. The invoke message (TC_INVOKE_REQ/IND) is a message used when starting an operation. The return result message (TC_RESULT_L_REQ/IND) is a message used when returning the last result after successful performance of the operation. The return error message (TC_U_ERROR-REQ/IND) is a message indicating that performance of the operation resulted in failure. The cancel message (TC_L_CANCEL_REQ/IND) is a message indicating that performance time has passed before performance of the operation is completed. The reject message (TC_L_REJECT_REQ/IND) is a message indicating that the component information in TCAP of the system, in which the ASE is included, is incorrect information. The remote reject message (TC_R_REJECT_REQ/IND) is a message indicating that the component information in TCAP of the other system is wrong information. The user reject message (TC_U_REJECT_REQ/IND) is a message indicating that the component information is rejected by the ASE.

For the MAP protocol encoding and decoding function, a MAP protocol process AP gives and takes encoded messages to and from the TCAP function AP. The respective MAP protocol process AP processes the MAP protocol message transmitted from a mobile communication system of another party by decoding the MAP protocol message. When transmitting the result to the mobile communication system of the other party, the MAP protocol process AP encodes a structured message used in the MAP protocol process AP.

At this time, the encoding function outputs a encoded message from the inputted MAP protocol process internal structure, and the decoding function outputs a MAP protocol process internal structure from the inputted encoded message. The MAP protocol process APs exchange messages using the functional internal structures within the MAP protocol process APs.

For the function of administrating the context pool, a MAP protocol process AP contains a certain number of unit context pools. A transaction that performed one unit context pool stores the current AP performance state so that the performance may be made by the next unit context pool. The context pool administrating AP takes charge of this function (not illustrated in the drawing for convenience). These functions are included in the MAP function.

The overall performance of the MAP protocol process AP is a combination of performances of a number of unit context pools having a certain order corresponding to the relevant situation. The structure that stores information about one unit transaction is called a context pool. The combination thus processes the protocol while making parallel performances of transactions possible by permitting overlap with other combinations of transactions.

The input into a context pool administrating AP is a context pool ID, when the already allotted context pool is about to be returned. When a new context pool is to be allotted, the input to a context pool administrating AP may be the TCAP protocol related information such as a transaction ID and a protocol invoke ID and information for entity requiring the context pool allotment such as a Queue ID or a process ID. Further, when a new context pool is to be allotted, the output becomes a new context pool ID.

As for the ID administrating function of the transaction ID and protocol message invoke ID, the transaction ID is a parameter used for distinguishing a certain transaction from a number of other transactions, which are set up for the respective transaction user and is administrated in the TCAP.

The relevant transaction is generated, progressed, and deleted according to the transaction request primitive (such as BEGIN, END, CONTINUE, and ABORT) inputted by the user. State transitions (such as Init Sent, Init Received, Idle, and Active) are made according to the generation, progress, and deletion of the transaction.

Specifically, if the user requests the beginning of a transaction with the message BEGIN, a new transaction ID is allotted. If the user requests the end of a transaction with the message END, the relevant transaction is ended and simultaneously the relevant transaction ID is released.

The message invoke ID is a parameter used for matching a component with a certain transaction. Like the transaction ID, the message invoke ID is administrated in the TCAP.

The relevant component is generated if a user pages an invoke primitive. At that time, a new message invoke ID is allotted. By the user's paging a result primitive, the relevant component is deleted and the relevant message invoke ID is released.

The database function will be explained next. For performing the call processing and additional service functions related to the call processing, the profile of the relevant subscriber and additional service information should be able to be searched in a database (not illustrated for convenience) and additional service information of the subscriber should be able to be changed. Also, if errors occur while access to the relevant database is attempted, the relevant database should perform the relevant process in accordance with the errors.

Referring to FIG. 2, an operation of processing a context pool in a MAP protocol process AP 120 will be described.

First, if the TCAP 200 transmits to the MAP protocol process AP 120 a new MAP protocol message to be processed by the MAP protocol process AP 120, the MAP protocol process AP 120 checks whether the MAP protocol message received from the relevant TCAP 200 is a MAP protocol message that can be processed without allotment of a context pool 110.

If the MAP protocol message is not a MAP protocol message that can be processed without an allotment of a context pool 110, the MAP protocol process AP 120 requests a context pool administrating AP to allot a context pool 110.

Thus, the context pool administrating AP allots a context pool 110 in the common memory upon receiving the request from the MAP protocol process AP 120. The context pool administrating AP allots a new context pool ID, stores the state, and returns the context pool ID allotted as a result to the MAP protocol process AP 120. Here, the context pool uses the common memory.

The above-described operations will be described in more detail through examples as follows. AP1 in the MAP protocol process AP 120 receives a MAP protocol message from the TCAP 200. At this time, it is determined whether the MAP protocol message received from the TCAP 200 is a MAP protocol message that may be processed without an allotment of a context pool 110.

If the received MAP protocol message is not a MAP protocol message that may be processed without the allotment of a context pool 110, the AP1 requests that the context pool administrating AP allot a new context pool 110 in the common memory.

Then, upon receiving the request from the AP1, the context pool administrating AP allots a context pool 110. The context pool administrating AP allots a new context pool ID, stores the state, and returns the context pool ID allotted as a result to the AP1.

AP2 through APn in the MAP protocol process AP 120 also receive MAP protocol messages from the TCAP 200 and request that the context pool administrating AP allot new context pools 110. The context pools 110 are thereby allotted in the same manner as described above.

The respective APs in the MAP protocol process AP 120 return the allotted context pools 110 after processing the relevant-received MAP protocol messages, and retransmit the result messages back to the TCAP 200. Here, information such as transaction ID, protocol invoke ID, block ID of the AP itself, and context pool ID is stored in the context pool 110 and the AP's own context pool 110 is checked using such information.

The above-described MAP protocol process AP, for processing MAP protocol, stores its own performance information in a context pool and returns the context pool when the relevant transaction ends so that the returned context pool may be used for other MAP protocol message process. Also, in order to perform one operation, the MAP protocol process AP needs to exchange many messages with a number of peripheral processes (such as Query Manipulate Interface (QMI), TCAP protocol process AP, process administrating AP, and measurement statistics process AP, etc.). Thus, the time required to complete the performance of one user request transaction is indefinite.

Accordingly, if the next transaction is performed after one transaction is completely performed, it is impossible to maintain parallel performance in processing protocols requested to be processed simultaneously. Thus, a MAP protocol process AP includes a context pool administrating AP, having a number of unit context pools. The context pool administrating AP manages context pools so that a transaction that has performed one unit context pool may store the current AP performance state, and so that the performance may be made by the next unit context pool.

As described above the related art has various problems. For example, although some transactions can be performed in a short time (for example, within several tens of seconds, at most) without interrupting other APs' performance, as a MAP protocol messages that need transactions having long performance time (for example, longer than several tens of minutes) appear, various problems are encountered in attempting to implement such MAP protocol messages. One of the problems is that as the number of transactions having long performance time increases, the context pool IDs are depleted and the performance of other APs are delayed.

In other words, the depletion of the limited context pools causes the interruption to other MAP protocol processes. Further, in order to resolve such problems in the related art, the difficult task of securing context pools in the common memory, in addition to maintaining the maximum transaction throughput of a system, has to be conducted. Also, because the standard of determining the size of a context pool in accordance with probability statistics of characteristic and kinds of message traffics in a mobile communication system has not been clearly established, there are other various problems.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the present invention is to return a context pool in the common memory, that is used simultaneously by all APs, within a short period of time.

Another object of the present invention is to maintain a processing capacity of a mobile communication system by not interrupting other APs' performance, by reducing the life cycle of an AP.

Another object of the present invention is to reduce a life cycle of an AP by storing in a database transaction IDs and information related to APs having long life cycles among all of the APs that process MAP protocol message exchanges at the time of MAP protocol message exchange between mobile communication systems.

An object of the present invention, for performing the MAP protocol process in a mobile communication system, is to prevent problems of interruption to other MAP protocol processes caused by depletion of the limited context pool and to maintain the system performance by storing the information related to a MAP protocol process not in the context pool but in a database separately for MAP protocol messages that require long transaction times, by continuously updating and storing the performance information and state in the relevant database until the relevant transaction is completed and by finishing the relevant transaction completely by deleting the relevant information from the relevant database if the relevant transaction is finished.

In order to achieve at least the above objects in whole or in parts, there is provided a method of processing MAP protocol in the mobile communication system that stores and administrates the relevant AP related information in a separate memory or memory means based upon the standard of transaction time required for AP process of the mobile communication system.

Preferably, the standard of transaction time is to determine whether the transaction time exceeds the time preset by the user or not. The AP related information may be classified into two cases: a case where the transaction time exceeds the time preset by the user and the other case where the transaction time does not exceed the time preset by the user. The AP related information in the case where the transaction time does not exceed the time preset by the user is stored in a first memory and the AP related information in the case where the transaction time exceeds the time preset by the user is stored in a second memory.

Additionally, in order to achieve at least the above objects in whole or in parts, there is provided a method of processing MAP protocol in a mobile communication system to process certain transaction in an AP of the mobile communication system, including storing the relevant AP related information not in the common memory for storing general AP related information but in a separate memory or memory means; and administrating the AP related information through the separate memory or memory means until the transaction ends. Here, to process the certain transaction means to process MAP protocol and the certain transaction means the transaction that requires long transaction time over the preset standard time.

Preferably, the AP related information comprises information related to the AP process for the MAP protocol message that requires transaction having a long life cycle; transaction ID; MAP protocol invoke ID; performance state information; and MAP protocol message information. Also, the memory includes subscriber ID, outgoing/incoming process sorter, performance state information of the respective blocks and transaction ID list.

Additionally, in order to achieve at least the above objects in whole or in parts, there is provided a method of processing MAP protocol in the mobile communication system including storing AP related information that processes the relevant MAP protocol in a separate memory (separate from the common memory) for a MAP protocol message that requires transaction having a long life cycle at the time of the MAP protocol message exchange between mobile communication systems; updating the AP related information in the memory continuously when a request for process of related MAP protocol is further made until the transaction ends; and ending the transaction by deleting the AP related information from the memory when the transaction ends.

Storing the AP related information in the separate memory is preferably performed by determining whether the MAP protocol message received from the AP is a message that requires transaction having a long life cycle upon checking the MAP protocol message code of the received MAP protocol message; if the MAP protocol message is a message that requires transaction having a long life cycle, determining whether the message is a transaction request end message; if the MAP protocol message is not a transaction request end message, allotting a new context pool in the common memory and simultaneously performing tasks of searching for, changing, deleting and insetting the separate memory upon decoding the MAP protocol message; and after processing and encoding the MAP protocol message, returning the result message and storing the AP related information in the separate memory at the same time.

Storing the AP related information may further include setting up a transaction ending flag to perform the end of the relevant transaction if the MAP protocol message is a transaction request end message.

Additionally, updating the AP related information is performed, when a further request for a process of a related MAP protocol is made, to process the MAP protocol message continuously by searching the separate memory using the information related to the AP process and the MAP protocol message information as keys and then to store the relevant processed information in the separate memory again.

Updating the AP related information preferably includes returning the context pool allotted in the common memory when the AP related information was stored in the separate memory and determining whether the transaction ending flag has been set up; if the transaction ending flag has not been set up, checking whether the related MAP protocol process request has been received; and, if the related MAP protocol process request has been received, performing the related MAP protocol process and the encoding by searching the separate memory and restoring the AP related information and then returning the result message and updating the AP related information in the separate memory at the same time.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates the structure for processing MAP messages in a network entity of IMT-2000 core network related to the present invention.

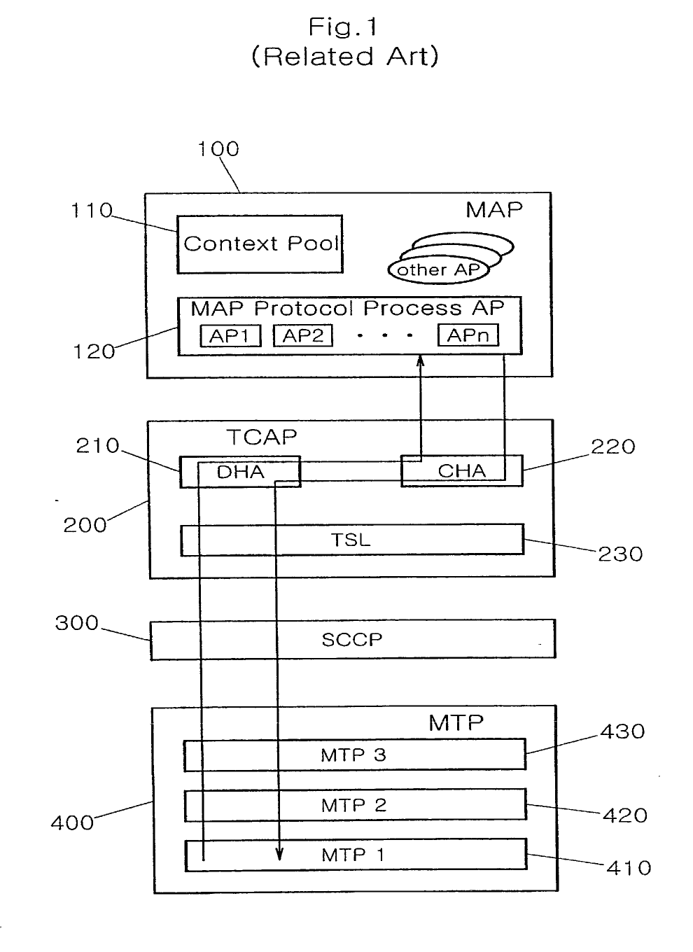

FIG. 2 illustrates the operation of processing a context pool in a MAP protocol process AP illustrated in FIG. 1.

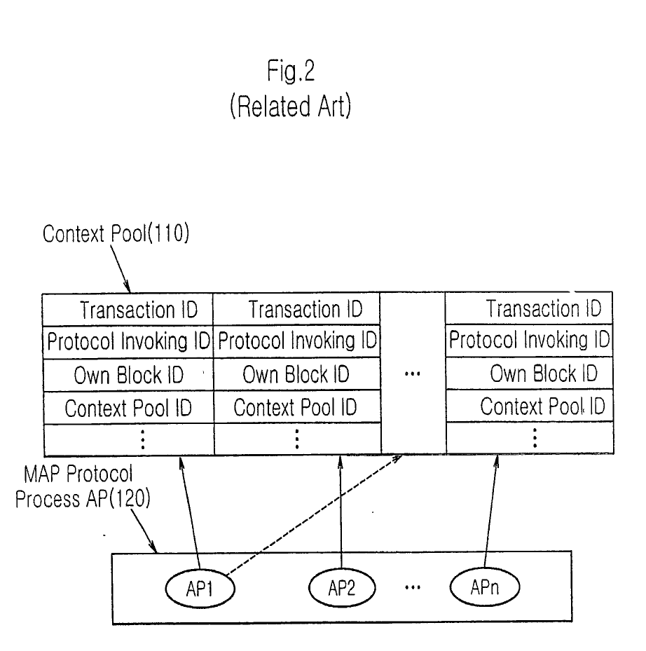

FIG. 3 is a flow chart illustrating a MAP protocol process method in a mobile communication system according to a preferred embodiment of the present invention.

FIG. 4 illustrates AP related information stored in the AP related information database illustrated in FIG. 3.

### DETAILED DESCRIPTION OF PREFERRED EMBODIMENTS

The preferred embodiment of the present invention stores the relevant AP related information in a separate memory according to the standard transaction time required for processing a certain transaction (such as a MAP protocol) in an AP of a mobile communication system. In other words, it is determined whether the transaction time exceeds the time preset by the user or not. If the transaction time does not exceed the time preset by the user, the AP related information is stored in a first memory. If the transaction time exceeds the time preset by the user, the AP related information is stored in the second memory.

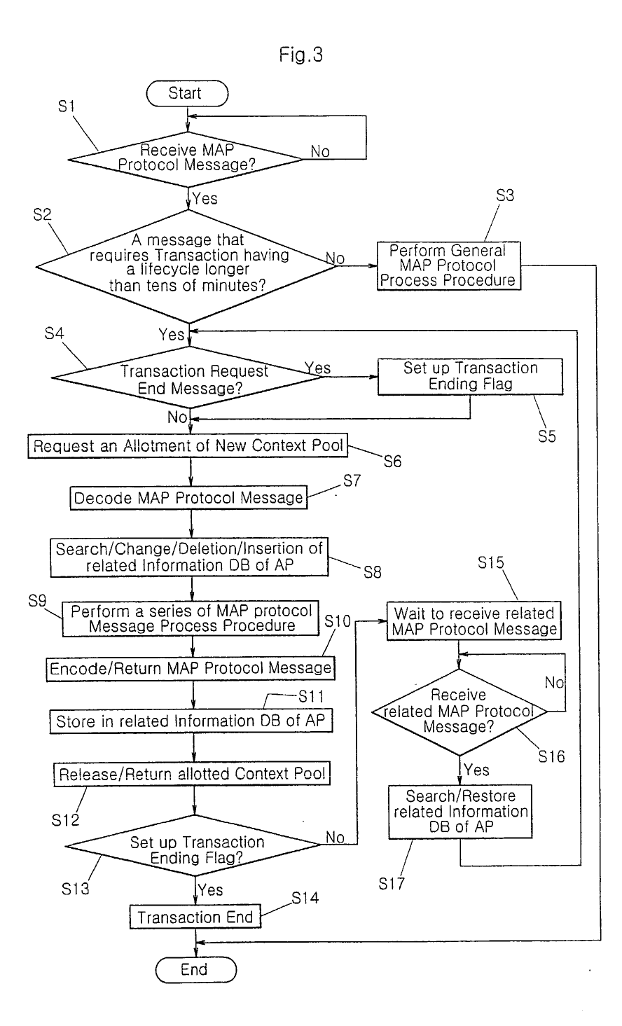

A method of processing MAP protocol in the mobile communication system according to a preferred embodiment of the present invention will be explained with reference to the flow chart in FIG. 3 as follows.

First, a MAP protocol process AP receives a MAP protocol message from TCAP (Si). The MAP protocol messages are asynchronous MAP protocol messages defined in the 3rd Generation Partnership Project (3GPP) and are over 50 or so. Each MAP protocol message has a unique MAP protocol message code.

Then, the MAP protocol process AP determines whether the MAP protocol message is a message that requires transaction having a long life cycle (for example, in some cases longer than tens of minutes) by checking the MAP protocol message code included in the MAP protocol message received from the TCAP (S2). For example, among supplementary services in the IMT-2000 core network, the message requesting the Completion of Calls to Busy Subscribers (CCBS) service may be a message that requires transaction having a long life cycle.

In step 2 (S2), if the MAP protocol message is not a message that requires transaction having a long life cycle (for example, not than tens of minutes), the MAP protocol process AP processes the relevant MAP protocol message according to the general MAP protocol process procedure (S3). Thus, in such a situation, the related art MAP protocol process procedure is used, and the relevant AP's performance information is stored in a context pool. When the relevant transaction ends, the context pool is returned for its use in processing other MAP protocol messages.

On the other hand, in step 2 (S2), if the MAP protocol message is a message that requires transaction having a long life cycle (such as over tens of minutes), the MAP protocol process AP determines whether the relevant MAP protocol message is a transaction request end message (S4).

In step 4 (S4), if it is determined the MAP protocol message is a transaction request end, the MAP protocol process AP sets up a transaction ending flag for performing an end of the relevant transaction (S5).

On the other hand, in step 4 (S4), if it is determined that the MAP protocol message is not a transaction request end message, the MAP protocol process AP requests the context pool administrating AP to allot a new context pool in the common memory The relevant context pool administrating AP then newly allots a context pool for the relevant transaction (S6).

Thereafter, the MAP protocol process AP decodes the MAP protocol message (S7), searches an AP related information database using the message, and performs change, deletion and insertion of the database (S8).

Then, the MAP protocol process AP preferably performs a series of MAP protocol message process procedure such as invoking the related MAP protocol message (S9). The related MAP protocol message is a message that requires a transaction having a long life cycle (for example, longer than tens of minutes) among MAP protocol messages that the MAP protocol process AP received from the TCAP.

At this time, the context pool and the AP related information database are loaded together in the common memory, but they preferably use different areas that are mutually independent. Thus, there is no relationship between the context pool and the AP related information database. Also, the context pool and the AP related information database have the following differences. Whereas the context pool has a fixed memory area structure and a relatively small size (i.e., megabyte size), the AP related information database has a variable memory area structure, and a larger size (i.e., 2 to 3 gigabytes). Further, the AP related information database may perform functions such as search, change, deletion, and insertion through queries of the Database Management System (DBMS).

The MAP protocol process AP encodes the MAP protocol message and then returns the result message to the TCAP (S10). At this time, AP related information such as the AP state information and the block performance information is stored in a separate memory. For example, in the AP related information database, which is different from the common memory used to store the general AP related information (S11).

Thereafter, the MAP protocol process AP transfers a release request of the context pool newly allotted in the common memory to the context pool administrating AP to have the relevant context pool returned (S12). Then, the MAP protocol process AP determines whether the transaction ending flag has been set up (S13).

In step 13 (S13), if the transaction ending flag is determined to have been set up, the MAP protocol process AP ends the relevant transaction (S14). At this time, if the relevant transaction ends, all information corresponding to the relevant transaction stored in the AP related information database is deleted.

On the other hand, if it is determined in step 13 (S13) that the transaction ending flag has not been set up, the MAP protocol process AP waits to receive the related MAP protocol message from the TCAP (S15).

The MAP protocol process AP determines whether there exists the related MAP protocol messages received from the TCAP (S16). If the relevant related MAP protocol message has been received, the relevant AP information is restored by searching the AP related information database and the relevant related MAP protocol message is processed (S17).

Until the transaction ends, the operations of step 4 (S4) to step 17 (S17) are repeated.

The operation of storing the AP related information in the AP related information database conducted in step 11 (S11) will be described in additional detail as follows.

First, for a MAP protocol message that requires transaction having a life cycle longer than a prescribed amount of time for example, tens of minutes, the MAP protocol process AP stores the AP related information, including information related to the AP process, a transaction ID, MAP protocol invoking ID, performance state information, and MAP protocol message information in the AP related information database so that the MAP protocol message requiring transaction having a life cycle longer the prescribed amount of time may be processed much more quickly. For example, a MAP protocol message requiring transaction having a life cycle longer than tens of minutes may be processed within tens of seconds.

Then, when a request for processing the related MAP protocol is further made, the relevant messages are continuously processed by searching the AP related information database using the information related to the AP process and the MAP protocol message information as keys. Thereafter, the processed information is stored in the AP related information database again and the above-mentioned operations are repeated until the relevant transaction ends completely.

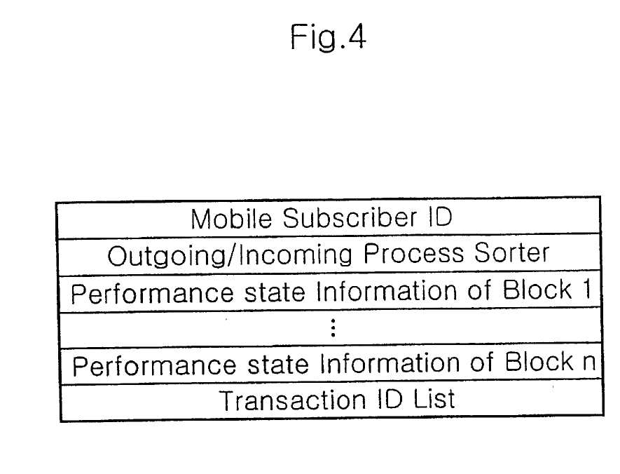

The AP related information database storing the AP related information may define and store a variety of information according to the relevant transaction. FIG. 4 illustrates AP related information stored in the AP related information database. The AP related information database preferably includes mobile subscriber ID, outgoing/incoming process sorter, and performance state information for block 1 to block n and transaction ID list.

Here, if a number of blocks in one MAP protocol process AP are related, performance state information of each of such related blocks is stored in the AP related information database. When the block performance is finished and the state is changed accordingly, such state change for the relevant block is recorded by changing the AP related information database and the relevant transaction is finished. When the entire transactions end completely, all of the information which has been stored in the AP related information database is deleted.

The present invention may be applied to the other mobile communication system structure that generates and deletes many APs. The description of the present invention is intended to be illustrative, and not to limit the scope of the claims. Many alternatives, modifications and variations of the present invention may be embodied to the extent apparent to those skilled in the art.

As described above, the present invention has many advantages. For example, it reduces the processing time of an AP having a long life cycle by storing the information related to the AP having a long life cycle in a database at the time of exchanging MAP protocol messages between the mobile communication systems. Also, the performance of the other APs is not interrupted. Thus, it is possible to maintain the process capacity of the mobile communication system. Further, even if a MAP protocol message that requires transaction having a long life cycle is processed without change of the existing structure, such process has little effect on the system performance and does not change the usage of the system resource. Consequently, the present invention has the effect of improving the system stability and system performance.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method of processing MAP protocol in a mobile communication system, comprising:
storing relevant AP related information in a prescribed one of a plurality of memories based upon a standard of transaction time required for an AP process of the mobile communication system; and
administrating the stored AP related information based upon the standard of transmission time.

2. The method of claim 1, wherein the standard of transaction time is used to determine whether a transaction time exceeds a prescribed amount of time.

3. The method of claim 1, wherein the AP related information comprises one of a case where the transaction time exceeds the prescribed amount of time and a case where the transaction time does not exceed the prescribed amount of time.

4. The method of claim 3, wherein the AP related information is stored in a first memory when the transaction time does not exceed the prescribed time and is stored in a second memory when the transaction time exceeds the prescribed amount of time, and wherein the first and second memories are distinct.

5. The method of claim 4, wherein the second memory is a context pool.

6. The method of claim 1, wherein the prescribed one of the plurality of memories is not a common memory of the mobile communication system.

7. A method of processing a MAP protocol in a mobile communication system, to process certain prescribed transactions in an AP of the mobile communication system, comprising:
storing relevant AP related information in a first memory, the first memory being separate from a common memory; and
administrating the AP related information through the first memory until the certain prescribed transaction ends.

8. The method of claim 7, wherein processing the certain transaction comprises processing the MAP protocol.

9. The method of claim 7, wherein the certain prescribed transaction is a transaction that requires a transaction time greater than a prescribed standard time.

10. The method of claim 7, wherein storing the AP related information comprises:
storing information related to the AP process for the MAP protocol message that requires a transaction having a long life cycle;
storing a transaction ID;
storing a MAP protocol invoke ID;
storing performance state information; and
storing MAP protocol message information.

11. A method of processing a MAP protocol in a mobile communication system, comprising:
storing AP related information that processes the MAP protocol in a first memory without storing the AP related information in a common memory for a MAP protocol message that requires a transaction having a life cycle greater than a prescribed period of time when the MAP protocol message exchange between mobile communication systems occurs;
continuously updating the AP related information in the first memory until the transaction ends; and
ending the transaction by deleting the AP related information from the first memory when the transaction ends.

12. The method of claim 11, wherein the AP related information in the first memory is continuously updated until the transaction ends when a request to process a related MAP protocol is further made.

13. The method of claim 11, wherein the first memory is not the common memory for storing general AP related information, and wherein the first memory comprises a memory means separate from the common memory.

14. The method of claim 11, wherein the AP related information comprises:
information related to the AP process for MAP protocol message that requires a transaction having a life cycle greater than a prescribed size;
a transaction ID;
a MAP protocol invoke ID;
performance state information; and
MAP protocol message information.

15. The method of claim 11, wherein storing the AP related information comprises:
determining whether the MAP protocol message received from the AP is a message that requires a transaction having the life cycle greater than the prescribed period of time upon checking the MAP protocol message code of the received MAP protocol message;
if the MAP protocol message requires transaction having the life cycle greater than the prescribed period of time, determining whether the message is a transaction request end message;
if the MAP protocol message is not a transaction request end message, allotting a new context pool in the common memory and simultaneously performing tasks of searching for, changing, deleting, and inserting the first memory upon decoding the MAP protocol message; and
after processing and encoding the MAP protocol message, returning the result message and storing the AP related information in the first memory at the same time.

16. The method of claim 15, wherein storing the AP related information further comprises setting up a transaction ending flag to perform the end of the transaction if the MAP protocol message is a transaction request end message.

17. The method of claim 11, wherein updating the AP related information comprises when a further request for a process of a related MAP protocol is made, processing the MAP protocol message continuously by searching the first memory using the information related to the AP process and the MAP protocol message information as keys, and then storing the relevant processed information in the first memory again.

18. The method of claim 11, wherein updating the AP related information comprises:
returning the context pool allotted in the common memory when the AP related information was stored in the first memory and determining whether the transaction ending flag has been set up;
if the transaction ending flag has not been set up, checking whether the related MAP protocol process request has been received; and
if the related MAP protocol process request has been received, performing the related MAP protocol process and the encoding by searching the first memory and restoring the AP related information, and then returning the result message and updating the AP related information in the first memory at the same time.

19. A mobile communication system configured to process a MAP protocol, comprising:
first and second memories, the first memory being configured to store AP related information for a MAP protocol message that requires a transaction having a life cycle greater than a prescribed period of time and the second memory being a common memory of the communication system;
means for storing the AP related information that processes the MAP protocol in the first memory for the MAP protocol message that requires the transaction having the life cycle greater than the prescribed period of time when the MAP protocol message exchange between mobile communication systems occurs, without storing the AP related information in the second memory;
means for continuously updating the AP related information in the first memory until the transaction ends; and
means for ending the transaction by deleting the AP related information from the first memory when the transaction ends.

20. The system of claim 19, wherein the second memory is a context pool.
